(19) United States
(12) Patent Application Publication
(10) Pub. No.: US 2003/0008133 A1
(43) Pub. Date: Jan. 9, 2003

(54) Anisotropic conductive film and method of fabricating the same for ultra-fine pitch COG application

(75) Inventors: Kyung wook Paik, Daejeon (KR); Myung jin Yim, Daejeon (KR)

Correspondence Address: OLIFF & BERRIDGE, PLC, P.O. BOX 19928, ALEXANDRIA, VA, 22320, US

(73) Assignee: Korea Advanced Institute of Science and Technology, Daejeon (KR)

(21) Appl. No.: 10/185,002

(22) Filed: Jul. 1, 2002

(30) Foreign Application Priority Data
Jul. 6, 2001 (KR) 2001-40386

(51) Int. Cl. B05D 5/12; B05D 3/02

(52) U.S. Cl. 428/332; 427/385.5; 427/58

(57) ABSTRACT

Disclosed are an anisotropic conductive film and a method of fabricating the same suitable for realizing an ultra-fine pitch COG (Chip On Glass) application. The anisotropic conductive film of the present invention is characterized in that 1-30% by volume nonconductive particles (polymer, ceramic, etc.) having a diameter 1/20-⅕ times as large as the conductive particles are added. According to the present invention, the anisotropic conductive film can prevent an electrical shorting between the bumps in bonding ultra fine pitch flip chip as well as in COG-bonding the driver IC. Accordingly, the anisotropic conductive film can be widely used in a communication field using ACA flip chip technology and universal flip chip packages.

### BACKGROUND OF THE INVENTION

1. Field of the Invention

The present invention relates to an anisotropic conductive film and method of fabricating the same, and more particularly, to an anisotropic conductive film and method of fabricating the same suitable for realizing an ultra-fine pitch COG (Chip On Glass) application.

2. Description of the Related Art

Liquid crystal display (LCD) is a representative of next generation flat panel displays. Since LCDs have characteristics, such as low power consumption, high picture quality, various market property, etc., they are receiving the spotlight. Liquid crystal display panel constituting the LCD is made by injecting liquid crystal polymer into a space between two sheets of transparent glass substrates. This LCD panel has a plurality of pixels. In order to display images, transmissivity of the respective pixels should be controlled. Thus, transmissivity of the light supplied from the backlight assembly is controlled by tilting liquid crystal molecules of the respective pixels while applying an electric field to the respective pixels. In order to levels of the electric field, it is requested to mount a driver IC for supplying voltages to an electric field forming device of the respective pixels through the signal lines.

Mounting technology of driver ICs that is a technical method for electrically connecting the LCD panel with the driver ICs, requires a fine-pitch connection, an easy connection process and a high reliability that are essentially followed by the complexity of the driver ICs, the increase in the number of pixels, and the requirement of high resolution. To meet the requirements in this driver IC mounting technology, there was developed the COG technology in which the bumps of the driver IC are facedown-bonded to an electrode of the LCD panel, for instance, the ITO electrode.

Some companies disclose various COG technologies. The most universal one is a mounting method in which a driver IC having bumps is heat-pressed using an anisotropic conductive film (ACF) to thus mount the driver IC on the LCD panel. During several years past, these anisotropic conductive films have been developed, and have a structure in which conductive particles are dispersed in thermosetting epoxy resin. The conductive particle uses a gold, silver, or other metal-coated polymer ball having a diameter ranged from 5 μm to 20 μm, a glass ball or the like. Depending on the amount of the conductive particles, a polymer matrix originally having non-. conductivity comes to have the anisotropic conductive property (when having a volume of 5-10%) or the isotropic conductive property (when having a volume of 25-35%).

Increase in the number of the pixels increases the number of the bumps in the driver IC, and decreases the pitch between the bumps. Accordingly, the bonding area of the bumps decreases and at the same time it is needed to increase the number of the conductive particles in the anisotropic conductive film so as to maintain a constant resistance. These increased conductive particles elevate the possibility of the electrical shorting between the bumps. This electrical shorting between the bumps may be generated by the following procedure. When a bumps-formed driver IC is bonded on the LCD panel on which the anisotropic conductive film is attached by applied heat and pressure, viscosity of the anisotropic conductive film decreases, and thus many conductive particles flow in a space between the bumps so as to fill the space while a flow of the anisotropic conductive film occurs. At this time, if the pitch between the bumps is small, several conductive particles are in contact with each other, so that the bumps are electrically shorted.

Briefly, when the COG bonding technology is used to mount a LCD driver IC having an ultra-fine pitch of 50 μm or less, an electrical short is generated between the adjacent bumps due to the shortened pitch between the bumps. Also, as the interval between the bumps goes to the ultra-fine pitch of 50 μm or less, the sectional area of the bump decreases. To this end, it is requested that many conductive particles form mechanical contacts between the bumps and the electrode of the LCD panel and many conductive particles exist in the anisotropic conductive film, the probability of the aforementioned electrical shorting increases.

In FIG. 1, there is shown an example in which an ITO electrode on an LCD panel is bonded to bumps of a driver IC. FIG. 1a is a plan view in which the driver IC is removed, and FIG. 1b is a sectional view taken along the line C-C′ of FIG. 1a, in which the driver IC exists. Referring to FIG. 1a, on an LCD panel 200 including a pair of glass substrates are arranged electrodes 230 and electrode pads 235 connected to the respective electrodes 230. These pads 235 are aligned with the bumps (not shown) of the driver IC, and are heat-pressed together with an anisotropic conductive film 220 consisting of conductive particles 224 and an inorganic filler 222 and interposed between the pads 235 and the bumps. Conventionally, the driver IC has the output bumps greater in number than the input bumps and thus the electrodes corresponding to the output bumps have more fine pitch than those corresponding to the input bumps. Accordingly, the electrodes corresponding to the output bumps have a probability higher in the electrical short due to the contacts between the conductive particles 224 than those corresponding to the input bumps. As shown in FIG. 4b, when the pads 235 are aligned with the bumps 240 of the driver IC 210, and are heat-pressed using the conventional anisotropic conductive film 220 to thereby perform a COG bonding, the viscosity of the resin in the anisotropic conductive film decreases, so that a flow of the resin along the horizontal direction is generated as indicated by arrows of FIG. 1a. Accordingly, the conductive particles flow too. In particular, the flow is generated highly around the bumps 240. If the resin flows in omni direction around the bumps 230, the conductive particles 224 flow together with the resin, so that introduction of the conductive particles 224 into the spaces between bumps 240 increases and thus contacts between the conductive particles 224 occur. As the bumps of the driver IC grow less and less to an ultra fine pitch, electrical connections due to clustering and contacts of the conductive particles grow more and more, so that electrical short phenomena occur.

In order to prevent the electrical short between the bumps, which may occur on the COG bonding process, the Japanese Sony Electronics Inc., applies a method in which a thin insulation film is coated on a metal-coated polymer particle to block the electrical connection path between the conductive particles. Hitachi Co. Ltd., are adopting a dual structure anisotropic conductive film in which a resin film no having the conductive particle is in contact with the bump side so as to minimize the flow of the conductive particles in the resin flowing in the space between the bumps, and a film layer containing the conductive particles is in contact with the glass substrate side.

Although the method employed by Sony electronics enhances the insulation performance between the conductive particles, it leaves a possibility in which the conductivity between the bump and the pad may be degenerated.

Also, according to the method of the Hitachi Co. Ltd., there may be caused a possibility in which production costs increase due to the complexity of the anisotropic conductive film structure.

### SUMMARY OF THE INVENTION

Therefore, it is a technical object of the present invention to provide an anisotropic conductive film and method of fabricating the same capable of preventing an electrical shorting between bumps, that may be generated while when a driver IC is bonded on an LCD panel with the anisotropic conductive film interposed therebetween by heat and pressure, viscosity decreases, so that a flow is generated so as to fill a vacant space between the bumps and thus many conducive particles flow in.

It is another object of the invention to provide an anisotropic conductive film and method of fabricating the same capable of preventing the number of the conductive particles between the bumps of the driver IC and the electrodes of the LCD panel to decrease due to the flow of the anisotropic conductive film.

To achieve the aforementioned objects of the present invention, there are provided an anisotropic conductive film and a method of fabricating the same suitable for realizing an ultra-fine pitch COG (Chip On Glass) application, characterized in that 1-30% by volume nonconductive particles (polymer, ceramic, etc.) having a diameter 1/20-1/5 times as large as the conductive particles are added. According to the present invention, the conductive particles are naturally insulated by the nonconductive particles, so that an electrical shorting between the bumps in bonding a driver IC having an ultra fine pitch. Also, when a resin flow is generated to fill the spaces between bumps together with decrease in the viscosity during heat pressing of the anisotropic conductive film, since movability of the conductive particles having a larger diameter relative to the nonconductive particles is restrained, the number of the conductive particles participating in the electrical contact between the bumps of the driver IC and the electrodes of the LCD panel is constantly maintained. Further, since the diameter of the nonconductive particles is much smaller than that of the conductive particles, the nonconductive particles do not have great influence on the conductivity between the bumps and the pads, so that ultra fine pitch bonding can be realized.

### BRIEF DESCRIPTION OF THE DRAWINGS

The above objects and other advantages of the present invention will become more apparent by describing in detail preferred embodiments thereof with reference to the attached drawings in which:

FIG. 1 is a schematic view for illustrating occurrence phenomenon of electrical shorting between bumps when conductive particles fill spaces between bumps for an ultra-fine pitch driving IC for the COG connection;

FIG. 2 is a schematic view of particles components contained in an anisotropic conductive film in accordance with a preferred embodiment of the present invention;

FIG. 3 is a plan view of a driving IC chip used in applications of the present invention, in which bumps, such as electroless nickel/gold bumps, gold-plated bumps, etc., are formed on I/O of the driver IC chip by low cost non-solder bump process;

FIG. 4 is a schematic view for illustrating a process to connect an ITO electrode pad on an LCD panel with non-solder bumps of a driver IC chip using an anisotropic conductive film of the present invention; and

FIG. 5 is a schematic view for illustrating a principle to prevent through nonconductive particles filled in a space between driver IC bumps an electrical shorting which may be caused due to conductive particles filled in a space between the driver IC bumps when an anisotropic conductive film of the present invention is used for the COG connection of a driver IC.

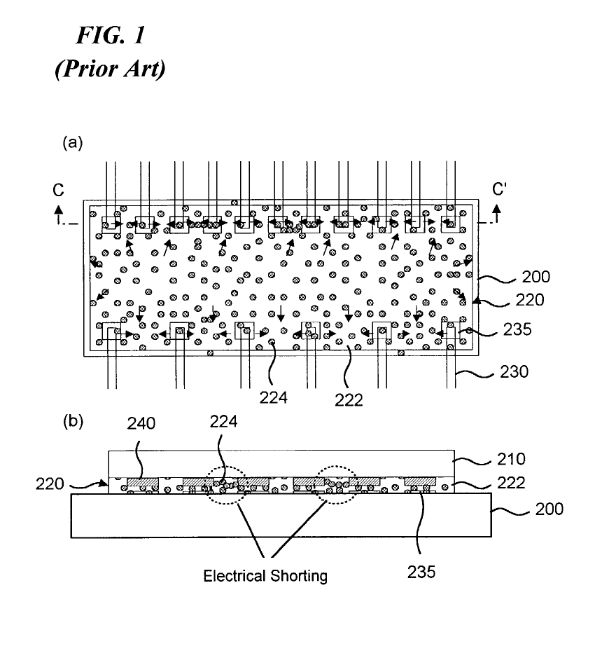

### DETAILED DESCRIPTION OF THE PREFERRED EMBODIMENTS

Now, preferred embodiments of the present invention will be described in detail with reference to the annexed drawings. In the various figures, the same references are used to designate elements that are identical or similar.

Fabrication of an Anisotropic Conductive Film for Ultra-Fine Pitch COG Applications

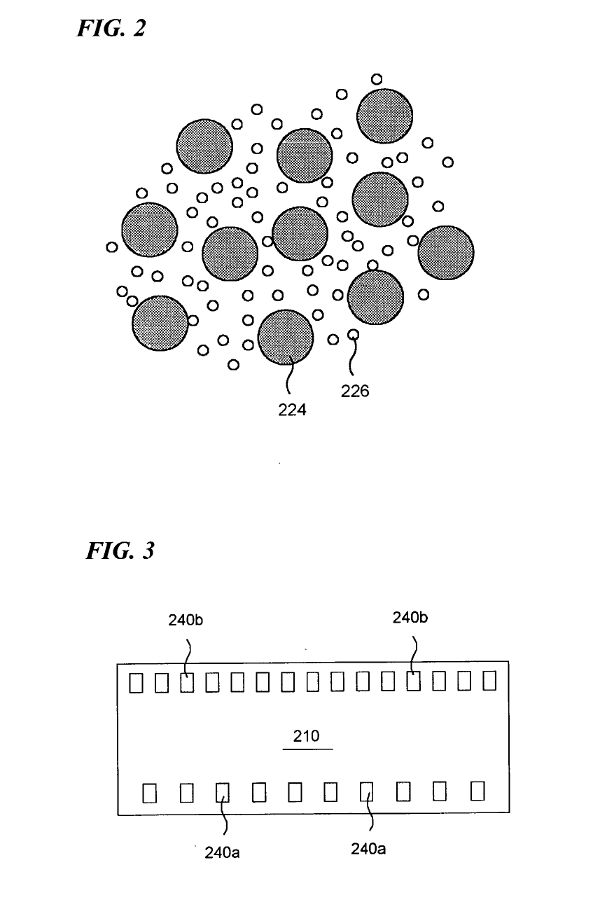

FIG. 2 is a schematic view of particles components contained in an anisotropic conductive film in accordance with a preferred embodiment of the present invention. Referring to FIG. 2, a plurality of conductive particles 224 and nonconductive particles 226 each having a constant size are mixed with each other, and a thermosetting epoxy resin is filled in a space between these particles. The conductive particle is 3 μm in diameter, and the nonconductive particle is 0.5 3 μm in diameter. In order to generate the effects of the present invention, it is desirous that the nonconductive particle has a diameter 1/20-1/5 times as large as the conductive particle and the nonconductive particles are dispersed in the epoxy resin by an amount of 1-30% by volume. Also, under a state satisfying the aforementioned conditions, it is preferably that the conductive particle has a diameter ranged from 3 μm to 10 μm and the nonconductive particle has a diameter of 1 μm or less.

Metal particles or metal-plated polymer particles can be used for the conductive particles. Meanwhile, polymer balls or ceramic balls can be used for the nonconductive particles. Then, if the polymer balls are used for the nonconductive particles, they may be made of Teflon or polyethylene. If the ceramic balls are used for the nonconductive particles, they may be made of alumina, silica, glass or silicon carbide.

The anisotropic conductive film is fabricated by the following method.

To begin with, an epoxy resin in which solid epoxy, liquid epoxy, phenoxy, resin and methylethylketol (MEK)/toluene solvent are mixed, is prepared. Subsequently, a particle mixture in which a plurality of conductive particles having a predetermined diameter, and a plurality of nonconductive particles having a diameter 1/20-1/5 times as large as the diameter of the conductive particle, are mixed with the epoxy resin at room temperature for 0.5-3 hours. In order to help a uniform mixing of the conductive particles and the nonconductive particles, 2-4% by weight of 3-glycidyloxy propyl trimethoxy silane is added to the resultant material of the mixing step. Afterwards, 50% by weight of epoxy imidazole hardener and epoxy are added to a resultant material resulting from the previous step, and are stirred to mix the epoxy imidazole hardener, the epoxy and the resultant material for 0.5-2 hours. To remove a bubble from the resultant material, a vacuum inhalation is carried out. Thereafter, the resultant material is coated on a release agent film to a thickness of 10-50 μm. The coated resultant material is dried at a temperature of 70-90° C. for 30 seconds to 2 minutes to remove solvent from the coated resultant material, thereby completing an anisotropic conductive film.

In the mixing the conductive particles with the nonconductive particles, the number of the mixed conductive particles is controlled by an electrical resistance between the driver IC and the bumps. Thus, the fabricated anisotropic conductive film is kept in the wound state to be matched with the COG bonding technology of the driver IC.

Embodiment

1. Bumps-Formed Driver IC Chip

FIG. 3 is a plan view of a driver IC chip 210 used in applications of the present invention, in which bumps 240a, 240b, such as electroless nickel/gold bumps, gold-plated bumps, etc., are formed on input/output (I/O) terminals of the driver IC chip 210 by a low cost non-solder bump process.

For the COG bonding using the anisotropic conductive film, there are needed bumps on the surface of the driver IC chip 210. Since the LCD panel has the ITO (Indium tin oxide) electrodes, which cannot be bonded by solder, the bumps of the driver IC are conventionally referred to as the “non-solder bump”. As shown in FIG. 3, the driver IC chip 210 has a long structure extending in one direction, in which input side bumps 240a and output side bumps 240b are arranged at both sides of the structure. The output side bumps 240 are connected with electrodes corresponding to the image signal lines of the LCD panel and the input side bumps 240a are also connected with electrodes of the LCD panel. These electrodes connected to the peripheral terminals via the interconnection lines on the LCD panel. These peripheral terminals are again connected to the driver PCB through the flexible PCB. Generally, since the number of the output signals is larger than that of the input signals, the number of the output side bumps 240b of the driver IC is larger than that of the input side bumps 240a of the driver IC. The input and output bumps 240a and 240b are formed on aluminum (Al) electrode pads exposed from silicon oxide (SiO₂) passivated on silicon layer. Au bumps are plated on the exposed aluminum electrode.

The bumps may be formed by an electroless plating method. A representative bump using the electroless plating method is nickel/gold bump. The electroless nickel/gold bump is formed by the electroless nickel/gold plating process at a thickness of 25 μm. In this case, in order to active the aluminum, zincate treatment is carried out. Afterwards, the specimen is dipped in an electroless nickel-plating solution having a proper temperature to thereby form a nickel bump. Then, to prevent oxidation of nickel and enhance the electrical conductivity, a thin gold film is plated.

Sectional structure of bumps formed by the aforementioned Au-plating method or the electroless plating method, is decided to be matched with the shape of the I/O pads.

Not using the plating method but using an Au wire, Au stud bumps may be formed. After the Au bumps are formed, a planarization process is performed so as to decrease a deviation in the height of the respective bumps. The planarization process is to widen the bonding area of the bumps by increasing deformation amount of the end portion of the bump when bonding the anisotropic conductive film. The planarization process prevents the chips from being damaged due to overpressure applied to a specific I/O pad by nonuniform height of the bumps. Also, it makes it easy to align and bond the chip and the substrate, thereby widening the contact area. This sectional structure of the stud bumps is mostly a circular, and sectional area thereof is smaller than that of the exposed I/O electrode.

2. COG Bonding Method Using Anisotropic Conductive Film

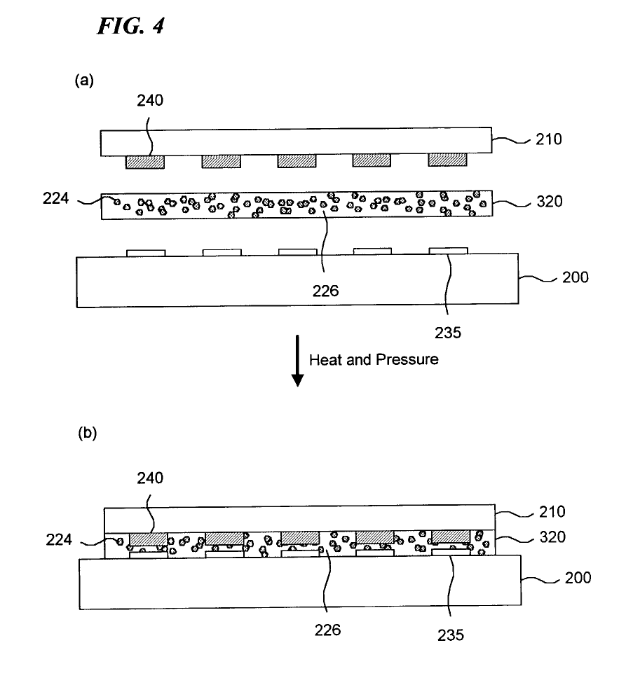

FIG. 4 is a schematic view for illustrating a process to connect an ITO electrode pad on an LCD panel with non-solder bumps of a driver IC chip using an anisotropic conductive film of the present invention.

If the conventional anisotropic conductive film is used to bond the ITO electrode pads with the bumps, increase in the density of the I/O pads and decrease in the sectional areas of the bumps may cause the conductive particles to decrease and to be distributed nonuniformly. Due to the decrease in the space between the bumps, decrease in the viscosity of the anisotropic conductive film during the heat pressure of the anisotropic conductive film is problematic, and the electrical shorting between bumps due to the increase in the density of the conductive particles by flow of the epoxy resin toward the space between the bumps is also problematic.

The COG bonding method using the anisotropic conductive film of the present invention is similar to that using the conventional anisotropic conductive film, and embodied example is described in the below.

First, as shown in Fig. a driver IC 210 on which bumps 230 are formed is aligned with ITO electrode pads 235 of an LCD panel 200 on which an anisotropic conductive film 320 is temporarily pressed. The temporary pressing is carried out at a temperature range of 80-100° C., at a pressure range of 50-100 N/cm² for 3-5 seconds. Subsequently, the driver IC 210 is heat-pressed to the LCD panel by applying heat and pressure at the same time. The main heat pressing is carried out at a temperature range of 170-180° C., at a pressure range of 200-400 N/cm² for 20-30 seconds. Afterwards, a carrier film of the anisotropic conductive film is removed. After the elapse of 20-30 seconds for the main heat pressing, the resultant structure is cooled while maintaining a predetermined applied pressure, so that a bonding structure shown in FIG. 4b is completed.

3. Prevention of Electrical Shorting Between Bumps

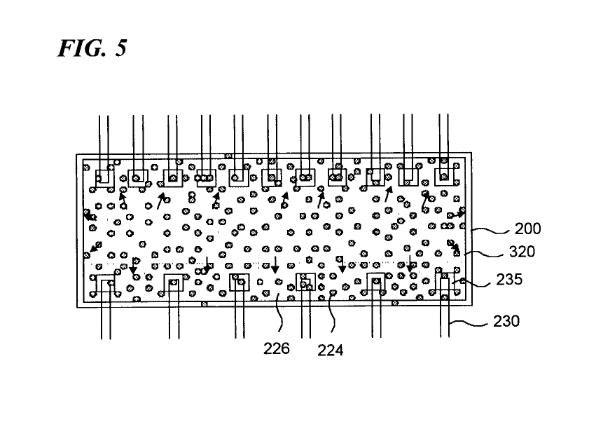

FIG. 5 is a schematic view for illustrating a principle to prevent through nonconductive particles filled in a space between driver IC bumps, an electrical shorting which may be caused due to conductive particles filled in a space between the driver IC bumps when an anisotropic conductive film of the present invention is used for the COG connection of a driver IC. FIG. 5 shows a planar structure after the driver IC is removed.

As sown in FIG. 5, if the anisotropic conductive film having an ultra fine pitch in accordance with the present invention is used to perform the COG bonding of the driver IC, although decrease in the viscosity of the anisotropic conductive film, and resin flow are generated, the resin flow amount in the anisotropic conductive film of the present invention is smaller relative to that in the conventional anisotropic conductive film. Also, although the resin flow is generated even around the bumps and thus many conductive particles are introduced, the natural insulation effect of the nonconductive particles 226 placed around the conductive particles 224 and having a size 1/5 times as large as the conductive particles 224, can prevents an electrical shorting between the bumps due to the contact between the conductive particles 224. Further, as the bumps of the driver IC grow less and less to an ultra fine pitch, the planar sectional area becomes shortened, so that the number of the conductive particles participating in the electrical conduction between the bumps and the LCD panel decreases, but the anisotropic conductive film of the present invention decreases the flow amount of the resin, thereby preventing the number of the conductive particles to decrease excessively.

As described previously, an anisotropic conductive film of the present invention can prevent an electrical shorting between the bumps in bonding ultra fine pitch flip chip as well as in COG-bonding the driver IC. Accordingly, the anisotropic conductive film can be widely used in a communication field using ACA flip chip technology and universal flip chip packages.

While the present invention has been described in detail, it should be understood that various changes, substitutions and alterations could be made hereto without departing from the spirit and scope of the invention as defined by the appended claims.

What is claimed is:

1. An anisotropic conductive film used in applications connecting a driver IC for an LCD using a COG technology, the film comprising:
a resin;
a plurality of conductive particles dispersed in the resin and each of which has a predetermined diameter; and
a plurality of nonconductive particles dispersed in the resin, and each of which has a diameter 1/20-1/5 times as large as the diameter of the conductive particle.

2. The anisotropic conductive film of claim 1, wherein the conductive particle has the diameter ranged from 3 μm to 10 μm, and the nonconductive particle has the diameter of 1 μm or less.

3. The anisotropic conductive film of claim 2, wherein the conductive particle is a metal particle or a metal-plated polymer particle.

4. The anisotropic conductive film of claim 2, wherein the nonconductive particle is a polymer ball or a ceramic ball.

5. The anisotropic conductive film of claim 1, wherein the resin is a thermosetting epoxy resin.

6. A method for fabricating an anisotropic conductive film, the method comprising the steps of:
(a) preparing an epoxy resin in which solid epoxy, liquid epoxy, phenoxy resin and methylethylketol/toluene solvent are mixed;
(b) mixing a particle mixture in which a plurality of conductive particles having a predetermined diameter, and a plurality of nonconductive particles each having a diameter 1/20-1/5 times as large as the diameter of the conductive particle, are mixed at room temperature for 0.5-3 hours, with the epoxy resin;
(c) adding 2-4% by weight of 3-glycidyloxy propyl trimethoxy silane to a resultant material resulting from the step of (b);
(d) adding 50% by weight of an epoxy imidazole hardener and epoxy to a resultant material resulting from the step of (c), and stirring and mixing the epoxy imidazole hardener, the epoxy and the resultant material resulting from the step of (c) for 0.5-2 hours;
(e) removing a bubble from a resultant material resulting from the step of (d) through a vacuum inhalation;
(f) coating a resultant material resulting from the step of (e) on a release agent film to a thickness of 10-50 μm; and
(g) drying the coated resultant material at a temperature of 70-90° C. for 30 seconds to 2 minutes to remove solvent from the coated resultant material.

7. The method of claim 6, wherein the nonconductive particles have an amount of 1-30% by weight with respect to an overall amount of the anisotropic conductive film

8. The method of claim 6, wherein the anisotropic conductive film has an electrical resistance, which is controlled by a number of the conductive particles as mixed.
